(19) United States
(12) Patent Application Publication
(10) Pub. No.: US 2024/0331029 A1
(43) Pub. Date: Oct. 3, 2024

(54) SYSTEMS AND METHODS FOR AUTOMATICALLY UPDATING ACCOUNT INFORMATION

(71) Applicant: Mastercard International Incorporated, Purchase, NY (US)

(72) Inventors: Sarah Russell, Ballwin, MO (US); Christopher T. Scholl, Manchester, MO (US)

(73) Assignee: Mastercard International Incorporated, Purchase, NY (US)

(21) Appl. No.: 18/193,307

(22) Filed: Mar. 30, 2023

(51) Int. Cl. G06Q 40/02; G06Q 40/03; H04L 9/40

(52) U.S. Cl. CPC G06Q 40/02; G06Q 40/03; H04L 63/0884

(57) ABSTRACT

An automatic name change computer includes a database and processor. An account information table includes a first record with a first account identifier. The processor receives an update file from a first server. The update file includes a second record including a second account identifier, a current legal name of a cardholder, and an updated legal name of the cardholder. Based on the account identifiers matching, the processor writes the updated legal name to the first record. The processor transmits a soft credit check inquiry to a second server and receives one or more accounts associated with the first account identifier. The processor presents a list of the accounts to a cardholder, receives a selection of one or more of the accounts, and writes the updated legal name to a cardholder update file. The processor then transmits the cardholder update file to an account provider.

### FIELD OF THE DISCLOSURE

The field of the disclosure relates generally to updating account information and, more particularly, to network-based systems and methods for automatically updating changed account data across a variety of accounts.

### BACKGROUND OF THE DISCLOSURE

There are many instances when a person may choose to change their legal name. For example, when someone gets married, they may choose to change their last name to their spouse's last name. Similarly, someone who gets divorced may choose to change their name back to their maiden name or choose a new name altogether. Furthermore, some people may simply prefer a different name than the one they were given at birth, either because they do not identify with their given name or because they feel that their name does not fit their personality. Additionally, transgender individuals may choose to change their name to one that is more consistent with their gender identity. Moreover, the reasons may include safety reasons (e.g., protect themselves from a stalker, abusive partner, or other threat) and religious or cultural reasons (e.g., to honor a particular ancestor or to adopt a new name upon conversion to a new religion). The decision to change one's legal name not only impacts a person's identity and sense of self, but also directly affects their legal identity.

If a person legally changes his or her name, it is important for that person to subsequently update their bank accounts and credit cards with their new name as soon as possible. This facilitates ensuring that that their financial transactions, statements, licenses, etc. are accurate and that one can avoid any confusion or potential fraud. Updating one's name with their bank accounts, credit cards, licenses, etc. can be very difficult. It can take months to get all credit cards, licenses, passport, utilities, etc. updated to reflect a name change.

### BRIEF DESCRIPTION OF THE DISCLOSURE

This brief description is provided to introduce a selection of concepts in a simplified form that are further described in the detailed description below. This brief description is not intended to identify key features or essential features of the claimed subject matter, nor is it intended to be used to limit the scope of the claimed subject matter. Other aspects and advantages of the present disclosure will be apparent from the following detailed description of the embodiments and the accompanying figures.

In one aspect, an automatic name change (ANC) system is provided. The ANC system includes a database, a processor, and a memory. The database includes an account information table stored thereon. The account information table includes a first record having a corresponding first account identifier. The memory includes computer-executed instructions stored thereon that, when executed by the processor, cause the processor to perform operations including receiving an update file from a first third-party server. The update file includes a second record including a corresponding second account identifier, a current legal name of a cardholder associated with the second account identifier, and an updated legal name of the cardholder. Based on the second account identifier matching the first account identifier, the processor writes the updated legal name of the cardholder to the first record of the account information table. The processor transmits a soft credit check inquiry to a second third-party server. The soft credit check inquiry is associated with the first account identifier. The processor also receives, from the second third-party server, one or more accounts associated with the first account identifier. Moreover, the processor presents a list of the one or more accounts associated with the first account identifier on a user interface of a cardholder computing device associated with the cardholder. Each of the one or more accounts is individually selectable. The processor receives, from the cardholder computing device, a selection of one or more of the one or more accounts. The processor then writes the updated legal name of the cardholder to a cardholder update file, wherein the cardholder update file includes only the selected one or more accounts associated with a single account provider. Furthermore, the processor transmits the cardholder update file to a computing device associated with the single account provider.

In another aspect, a computer-implemented method is provided. The method is performed by an automatic name change system that includes a database having an account information table stored thereon. The account information table includes a first record having a corresponding first account identifier. The method includes receiving an update file from a first third-party server. The update file includes a second record including a corresponding second account identifier, a current legal name of a cardholder associated with the second account identifier, and an updated legal name of the cardholder. The method also includes, based on the second account identifier matching the first account identifier, writing the updated legal name of the cardholder to the first record of the account information table. Furthermore, the method includes transmitting a soft credit check inquiry to a second third-party server. The soft credit check inquiry is associated with the first account identifier. Furthermore, the method includes receiving, from the second third-party server, one or more accounts associated with the first account identifier, and presenting a list of the one or more accounts associated with the first account identifier on a user interface of a cardholder computing device associated with the cardholder. Each of the one or more accounts is individually selectable. In addition, the method includes receiving, from the cardholder computing device, a selection of one or more of the one or more accounts. The method further includes writing the updated legal name of the cardholder to a cardholder update file, wherein the cardholder update file includes only the selected one or more accounts associated with a single account provider. Moreover, the method includes transmitting the cardholder update file to a computing device associated with the single account provider.

In yet another aspect, a non-transitory computer readable storage medium is provided. The non-transitory computer readable storage medium includes computer readable instructions that, when executed by a processor, cause the processor to perform operations including receiving an update file from a first third-party server. The update file includes a first record including a corresponding first account identifier, a current legal name of a cardholder associated with the first account identifier, and an updated legal name of the cardholder. The computer readable instructions also cause the processor to retrieve an account information table from a database. The account information table includes a second record having a corresponding second account identifier. Furthermore, the computer readable instructions cause the processor to match the first account identifier to the second account identifier and, based on the first account identifier matching the second account identifier, write the updated legal name of the cardholder to the first record of the account information table. Based on the computer-executable instructions, the processor transmits a soft credit check inquiry to a second third-party server. The soft credit check inquiry is associated with the first account identifier. The processor also receives, from the second third-party server, one or more accounts associated with the first account identifier. Moreover, the processor presents a list of the one or more accounts associated with the first account identifier on a user interface of a cardholder computing device associated with the cardholder. Each of the one or more accounts is individually selectable. The processor receives, from the cardholder computing device, a selection of one or more of the one or more accounts. The processor then writes the updated legal name of the cardholder to a cardholder update file, wherein the cardholder update file includes only the selected one or more accounts associated with a single account provider. Furthermore, the processor transmits the cardholder update file to a computing device associated with the single account provider.

A variety of additional aspects will be set forth in the detailed description that follows. These aspects can relate to individual features and to combinations of features. Advantages of these and other aspects will become more apparent to those skilled in the art from the following description of the exemplary embodiments which have been shown and described by way of illustration. As will be realized, the present aspects described herein may be capable of other and different aspects, and their details are capable of modification in various respects. Accordingly, the figures and description are to be regarded as illustrative in nature and not as restrictive.

### BRIEF DESCRIPTION OF THE DRAWINGS

The figures described below depict various aspects of systems and methods disclosed therein. It should be understood that each figure depicts an embodiment of a particular aspect of the disclosed systems and methods, and that each of the figures is intended to accord with a possible embodiment thereof. Further, wherever possible, the following description refers to the reference numerals included in the following figures, in which features depicted in multiple figures are designated with consistent reference numerals.

FIG. 1 is a schematic diagram illustrating a payment platform that includes an automatic name change (ANC) computing device, in accordance with one aspect of the present invention;

FIG. 2 is an example configuration of the ANC computing device of FIG. 1;

FIG. 3 is an example configuration of a computing system for use with the payment platform of FIG. 1;

FIG. 4 is an example configuration of a server system for use with the payment platform of FIG. 1;

FIG. 5 is a flowchart illustrating an exemplary computer-implemented method for registering a registrant for an automatic name change service provided by the ANC computing device of FIG. 1, in accordance with one embodiment of the present disclosure;

FIG. 6 is a flowchart illustrating an exemplary computer-implemented method for automatically updating an accountholder's legal name on one or more associated accounts using the automatic name change service provided by the ANC computing device of FIG. 1, in accordance with one embodiment of the present disclosure; and

FIG. 7 depicts a user interface of a user computing device of FIG. 1 depicting a selectable list of accounts for updating using the automatic name change service provided by the ANC computing device of FIG. 1.

Unless otherwise indicated, the figures provided herein are meant to illustrate features of embodiments of this disclosure. These features are believed to be applicable in a wide variety of systems comprising one or more embodiments of this disclosure. As such, the figures are not meant to include all conventional features known by those of ordinary skill in the art to be required for the practice of the embodiments disclosed herein.

### DETAILED DESCRIPTION OF THE DISCLOSURE

The following detailed description of embodiments of the invention references the accompanying figures. The embodiments are intended to describe aspects of the invention in sufficient detail to enable those with ordinary skill in the art to practice the invention. The embodiments of the invention are illustrated by way of example and not by way of limitation. Other embodiments may be utilized, and changes may be made without departing from the scope of the claims. The following description is, therefore, not limiting. The scope of the present invention is defined only by the appended claims, along with the full scope of equivalents to which such claims are entitled.

As used herein, the term “database” includes either a body of data, a relational database management system (RDBMS), or both. As used herein, a database includes, for example, and without limitation, a collection of data including hierarchical databases, relational databases, flat file databases, object-relational databases, object oriented databases, and any other structured collection of records or data that is stored in a computer system. Examples of RDBMS's include, for example, and without limitation, Oracle® Database (Oracle is a registered trademark of Oracle Corporation, Redwood Shores, Calif.), MySQL, IBM® DB2 (IBM is a registered trademark of International Business Machines Corporation, Armonk, N.Y.), Microsoft® SQL Server (Microsoft is a registered trademark of Microsoft Corporation, Redmond, Wash.), Sybase® (Sybase is a registered trademark of Sybase, Dublin, Calif.), and PostgreSQL. However, any database may be used that enables the systems and methods to operate as described herein.

### Example of Payment Card Transaction Network

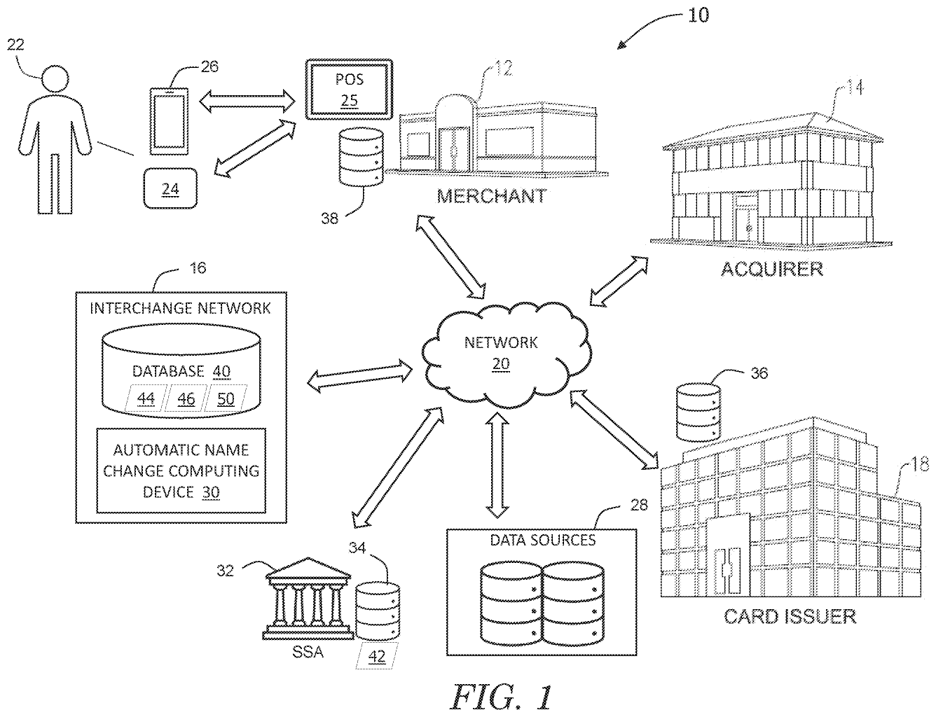

FIG. 1 is a schematic diagram illustrating a payment platform 10 that includes an automatic name change (ANC) computing device 30. Embodiments described herein may relate to a transaction card system, such as a payment card payment system using the Mastercard® interchange network. The Mastercard interchange network is a set of proprietary communications standards promulgated by Mastercard International Incorporated for the exchange of financial transaction data and the settlement of funds between financial institutions that are associated with Mastercard International Incorporated. (Mastercard is a registered trademark of Mastercard International Incorporated located in Purchase, New York).

In a typical transaction card system, a financial institution referred to as the “card issuer,” “issuer,” or “issuing bank,” represented by reference numeral 18, issues a transaction card 24, such as a credit card, debit card, and the like, to a cardholder 22, also referred to herein as a consumer or accountholder. In some embodiments, the transaction card 24 may be provisioned via a payment token (not shown) to a cardholder computing device 26. The cardholder 22 uses the transaction card 24 or the cardholder computing device 26 to tender payment for a purchase from a merchant 12.

To accept payment with the transaction card, the merchant 12 normally establishes an account with a financial institution that is part of the financial payment system. This financial institution is referred to as the “merchant bank,” the “acquiring bank,” or the “acquirer,” represented by reference numeral 14. In one embodiment, the cardholder 22 tenders payment for a purchase using the transaction card 24 or cardholder computing device 26 at a transaction processing device 25 (e.g., a point-of-sale (POS) terminal). The merchant 12 then requests authorization from the acquirer 14 for the amount of the purchase. The request is usually performed using the POS terminal 25, which reads account information from the transaction card 24 or cardholder computing device 26. The POS terminal 25 communicates electronically with transaction processing computers of the acquirer 14. In the context of transactions with online merchants, the cardholder 22 may provide his or her account information, such as his or her financial account number, a card verification number, an expiration date, and the like through a website. Alternatively, the acquirer 14 may authorize a third party to perform transaction processing on its behalf. In this case, the POS terminal 25 may be configured to communicate with the third party. Such a third party may be referred to as a “merchant processor,” an “acquiring processor,” or a “third party processor.”

Using an interchange network 16, computers of the acquirer 14 may communicate with computers of the issuer 18 to determine whether an account of cardholder 22 is in good standing and whether the purchase is covered by an available credit line and/or amount of funds of the account of the cardholder 22. Based on these determinations, the request for authorization may be declined or accepted. If the request is accepted, an authorization code may be issued to merchant 12.

In the example embodiment, the merchants 12, the acquirers 14, the interchange network 16, and the issuers 18, are coupled together in communication via an electronic network 20. The network 20 includes, for example and without limitation, one or more of a local area network (LAN), a wide area network (WAN) (e.g., the Internet, etc.), a mobile network, a virtual network, and/or any other suitable public and/or private network capable of facilitating communication among the merchants 12, the acquirers 14, the interchange network 16, and/or the issuers 18. In some embodiments, the network 20 may include more than one type of network, such as a private payment transaction network provided by the interchange network 16 to the acquirers 14 and the issuers 18 and, separately, the public Internet, which may facilitate communication between the merchants 12, the interchange network 16, the acquirers 14, and the cardholders 22, etc.

In addition to the transaction card 24, the cardholder 22 may have one or more other financial accounts with the issuer 18 and/or other financial institutions. For example, the cardholder 22 may have one or more credit cards, loans, mortgages, securities or investment accounts, and the like with other financial institutions. Each of these accounts are associated with cardholder information, such as the cardholder's name, address, contact information, social security number (SSN), and/or other unique identifier. These financial institutions, such as the issuer 18, may store cardholder account information corresponding to such accounts in an account information database 36.

Furthermore, the cardholder 22 may have additional accounts and/or licenses associated with different organizations and/or government entities, wherein each of such accounts/licenses are associated with cardholder information, such as the cardholder's name, address, contact information, social security number (SSN), and/or other unique identifier. Such organizations/government entities may store the cardholder account information corresponding to such accounts in various account information data sources, represented by data sources 28. Furthermore, it is noted that most financial accounts, licenses, government identifiers (e.g., driver's license, passport, etc.), and the like include a cardholder's SSN as part of the cardholder information.

The United States Social Security Administration (SSA) is an independent agency of the U.S. federal government that issues an SSN to individuals (e.g., U.S. citizens, permanent residents, and temporary (working) residents). The nine-digit SSN has become a de facto national identification number for taxation and other purposes in the U.S. The SSN and associated individual data, such as an individual's legal name, is kept by an SSA server 32 (broadly, a third-party server), for example, in an SSA database 34. In an example embodiment, the SSA server 32 may provide an update file 42 to one or more entities that require an individual's updated data, such as an individual's updated or changed legal name.

Merchants, such as the merchant 12, may also store payment card account information corresponding to one or more cardholders in a merchant account information database 38. In certain embodiments, the merchant account information database 38 may be a local or remote database accessible to the POS terminal 25 and/or other computers of the merchant 12. During a transaction, the merchant 12 may retrieve account information from the merchant account information database 38 as opposed to acquiring the information from the cardholder 22, such as by having the cardholder 22 provide his or her payment card account information by swiping the payment card 24, tapping the cardholder computing device 26, and/or otherwise entering payment card information. Such transactions are referred to as “account-on-file” transactions. “Account-on-file” transactions may include recurring payments such as subscription fees, membership fees, electronic bills, and the like. In an embodiment, the merchant 12 may be an internet service provider (ISP) that provides internet connectivity to the cardholder 22 in exchange for a monthly service fee. The cardholder 22 may enroll in an automatic bill pay service with the ISP to pay for the monthly service charge. The ISP may store the cardholder's account data in the merchant account information database 38. When the monthly service charge is due, the ISP may retrieve the account data from the merchant account information database 38 and may submit a transaction based on the retrieved account data to the issuer 18.

Although storing cardholder account information on file is often required for a cardholder's accounts/licenses/IDs, and account-on-file transactions provide improved efficiency for both merchants and cardholders, cardholder account information is subject to change. For example, if a cardholder changes his or her legal name, such as due to a marriage, divorce, court order, and/or other reason, the name change needs to be updated with each account/license/ID of the cardholder 22. In other examples, if the merchant 12 attempts to submit a transaction to the issuer 18 after such a name change and uses out-of-date account information, the issuer 18 may reject the transaction. Furthermore, access to the cardholder's account(s) may be inhibited by a legal name change.

Accordingly, the automatic name change (ANC) computing device 30 may be implemented to ensure that cardholder account data maintained by the various organizations (e.g., the merchant 12, the issuer 18, other data sources 28, etc.) is current. Specifically, in the example embodiment, the ANC computing device 30 may periodically receive name change data updates, for example via the update file 42, from the SSA server 32 and store the received name change data in an ANC information database 40. ANC computing device 30 may then make the stored name change data available to the merchant(s) 12 so that the merchant(s) 12 may update merchant account information database(s) 38, the issuer(s) 18 so that issuer(s) 18 may update the account information database(s) 36, and/or the organizations associated with the various data sources 28.

In certain embodiments, the ANC information database 40 may store account information, such as current legal name, a current address, and contact information (e.g., phone number, email, etc.), for one or more cardholders, such as the cardholder 22, in an account information table 44. For each account of a cardholder, the ANC information database 40 may also include, as part of the account information table 44, outdated account information that is linked to the corresponding current account information (e.g., a previous legal name, address, and/or contact information). As a result, the ANC computing device 30 can use the outdated account information to locate the corresponding current account information in the ANC information database 40, for example, based on any submitted outdated account information.

In an embodiment, to obtain updated and/or current account information about an individual(s), such as the cardholder 22, the ANC computing device 30 submits an update request to the SSA server 32. The update request may include one or more account identifiers, such as SSNs, corresponding to cardholders for which the interchange network 16 is requesting current account information. In response to the update request, the SSA server 32 may retrieve corresponding current account information from the SSA database 34 and transmit a response message (e.g., the update file 42) containing the current account information to the interchange network 16 via the ANC computing device 30. Alternatively, the ANC computing device 30 may automatically receive an update file 42 from the SSA server 32 at a predetermined interval (e.g., weekly, monthly, etc.).

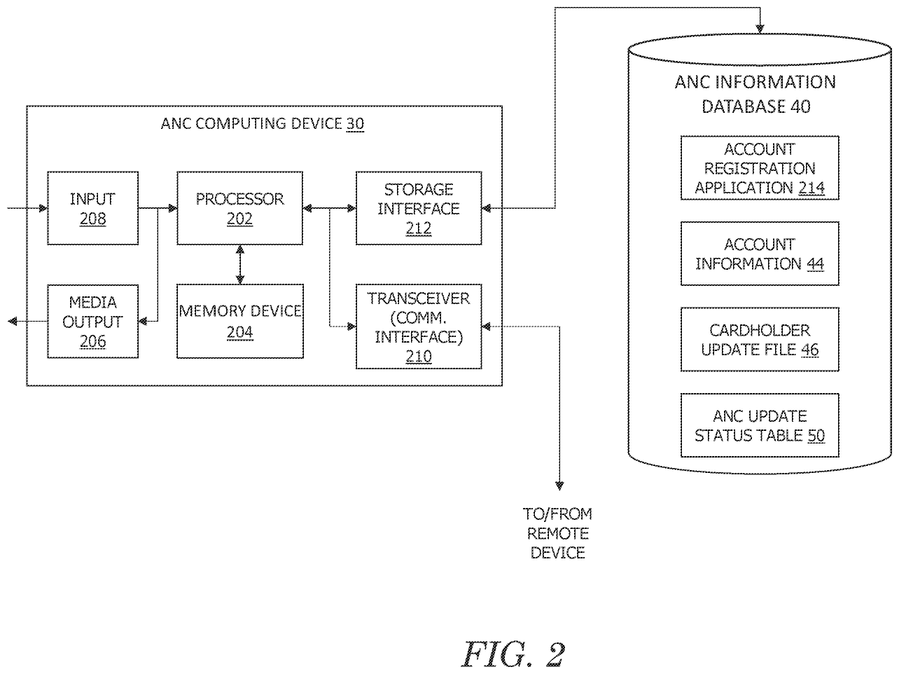

In certain embodiments, the ANC computing device 30 pushes a cardholder update file 46 to one or more card issuers 18, merchants 12, and/or organizations/government entities, as represented by the data sources 28. Alternatively, the one or more card issuers 18, merchants 12, and/or organizations/government entities may access the cardholder update file 46 via an application programming interface (API) system 48 (see FIG. 2).

In some embodiments, the one or more card issuers 18, merchants 12, and/or organizations/government entities may send a receipt notification back to the ANC computing device 30 indicating whether the one or more card issuers 18, merchants 12, and/or organizations/government entities successfully updated the cardholder account information in their respective databases 36, 38, and 28 with the current account information received, for example, via push notification and/or API request.

In response to receiving the receipt notification, the ANC computing device 30 may create/write a new entry or update an existing entry in an ANC update status table 50. The ANC update status table 50 generally stores data regarding ANC update activity. For example, the ANC update status table 50 may include one or more account identifiers (e.g., SSNs). For each respective account identifier, the ANC update status table 50 may include a record of each associated account and/or license associated with different organizations and/or government entities to be updated, along with information indicating when each account and/or license was last updated. For example, and without limitation, the ANC update status table 50 may include, for each respective card issuer 18, merchant 12, and/or organization/government entity, one or more of: a date/time of the last update pushed and/or update request received; a date/time of a last receipt notification received from the respective entity; and whether the latest receipt notification indicated a successful update to the account information kept by the entity.

In certain embodiments, the ANC computing device 30 may determine, based on data contained in the ANC information database 40 and ANC update status table 50, that an entity has not received current account information corresponding to an account identifier. For example, the ANC computing device 30 may determine that one or more card issuers 18, merchants 12, and/or organizations/government entities has not submitted an update request (e.g., via the API system 48) and/or received a push message with the cardholder update file 46 since a most recent update of the account information table 44 stored on the ANC information database 40. In response to the determination, the ANC computing device 30 may automatically push the most recent cardholder update file 46 to the respective entity and/or generate a notification message indicating that the entity has outdated cardholder account information on file. The ANC computing device 30 may transmit the notification message to the respective entity. Similarly, the ANC computing device 30 may be configured to automatically push the cardholder update file 46 and/or generate and transmit a notification message to the one or more card issuers 18, merchants 12, and/or organizations/government entities whenever the ANC computing device 30 receives updated account information from the SSA server 32.

The ANC computing device 30 may be configured to perform a soft credit check on each account identifier to identify accounts and/or licenses that are associated with the account identifier. A soft credit check is a type of inquiry made by the ANC computing device 30 on an individual's credit report that does not affect the individual's credit score. A soft credit check is performed by accessing the individual's credit report from a credit bureau with the individual's permission and using the individual's SSN. The ANC computing device 30 reviews the credit report to identify the financial accounts licenses, etc., to determine which organizations and/or entities should receive updated account information.

The ANC computing device 30 may be configured to generate and transmit a notification to the cardholder 22 based on the identification of the organizations and/or entities that should receive updated account information. For example, in some embodiments, the ANC computing device 30 may be configured to provide a notification including a link or file that includes the identified organizations and/or entities which should receive updated account information. In some embodiments, the ANC computing device 30 may perform a step-up authentication process (i.e., two-factor authentication process) on the individual before providing access to the link and/or file. For example, the ANC computing device 30 may provide a one-time password to the cardholder 22, for example, via a cardholder computing device.

In addition to generating and transmitting a notification to the cardholder 22, the ANC computing device 30 may also present a list of results tied to the cardholder's SSN as identified via the soft credit check. For example, the ANC computing device 30 may provide a screen to the cardholder 22 on a cardholder computing device, wherein the screen includes a list including each account, organization, and/or entity that requires updated account information associated with the cardholder 22. For example, and without limitation, a list may include the cardholder's driver's license account, passport, bank checking account, bank savings account, credit card account, mortgage account, automotive loan accounts, and the like. Each account may be associated with a check box and/or other method that allows the cardholder 22 to select each respective account.

In an embodiment, the ANC computing device 30 may receive one or more account selections from the cardholder 22, for example, via the presented list of results. For example, the cardholder 22 may select each account that he or she wishes to have automatically updated via the ANC computing device 30. Upon receipt of the cardholder selections, in some embodiments, the ANC computing device 30 will present a confirmation screen indicating each option selected by the cardholder. The confirmation screen may include an icon or check box that may selected by the cardholder to confirm that he or she wishes each listed account to be updated.

### Exemplary Computer Systems

FIG. 2 is an example configuration of the ANC computing device 30, which is part of the payment platform 10, and more particularly, the interchange network 16 (shown in FIG. 1), in accordance with one aspect of the present disclosure. In the exemplary embodiment, the ANC computing device 30 is a computing device configured to connect to one or more of the cardholder payment card 24 and/or cardholder computing device 26, the card issuer 18, the merchant 12, the acquirer 14, the SSA server 32, the data sources 28, and any other computing devices, via the network 20.

In the example embodiment, the ANC computing device 30 includes one or more processors 202 for executing instructions. In some embodiments, executable instructions are stored in a memory device 204. The processor 202 may include one or more processing units arranged, for example, in a multi-core configuration. The memory device 204 is any device allowing information such as executable instructions, data, and/or written works to be stored and retrieved. The memory device 204 includes one or more computer readable media. The processor 202 is operable to execute the executable instructions, contained in program instructions, operations, and/or steps described herein, so as to control the ANC computing device 30 to provide desired functionality.

The ANC computing device 30 also includes at least one media output component 206 for presenting information to a user (not shown). The media output component 206 is any component capable of conveying information to the user. In some embodiments, the media output component 206 includes an output adapter such as a video adapter and/or an audio adapter. An output adapter is operatively coupled to the processor 202 and operatively connectable to an output device such as a display device, a liquid crystal display (LCD), light emitting diode (LED) display, organic light emitting diode (OLED) display, “electronic ink” display, etc. and/or an audio output device, such as a speaker, or headphones.

In some embodiments, the ANC computing device 30 includes an input device 208 for receiving input from the user. The input device 208 may include, for example, a touch sensitive panel, a touch pad, a touch screen, a stylus, a photographic element or camera, an optical sensor, a gyroscope, an accelerometer, a position detector, a keyboard, a pointing device, a mouse, or an audio input device. A single component such as a touch screen may function as both an output device of the media output component 206 and the input device 208.

The ANC computing device 30 also includes a transceiver 210 (broadly, a communication interface), which is communicatively connectable to one or more remote devices such as the cardholder computing device 26, the card issuer 18, the merchant 12, the acquirer 14, the SSA server 32, the data sources 28, and any other computing devices, via the network 20. The transceiver 210 may include, for example, a wired or wireless network adapter or a wireless data transceiver for use with radio frequency communication, near field communication (NFC), and/or with a mobile phone network, Global System for Mobile communications (GSM), 3G, or other mobile data network, and/or Worldwide Interoperability for Microwave Access (WiMax) and the like. The transceiver 210 may include numerous communication ports (not shown) to enable the ANC computing device 30 to communicate simultaneously with a number of other computers and other devices, including communications as required to simultaneously handle numerous transactions.

In some embodiments, the processor 202 is operatively coupled to the ANC information database 40 via a storage interface 212. The storage interface 212 is any component capable of providing the processor 202 with access to the ANC information database 40. The storage interface 212 may include, for example, an Advanced Technology Attachment (ATA) adapter, a Serial ATA (SATA) adapter, a Small Computer System Interface (SCSI) adapter, a RAID controller, a SAN adapter, a network adapter, and/or any component providing the processor 202 with access to the ANC information database 40.

The ANC information database 40 is any computer-operated hardware suitable for storing and/or retrieving data. In some embodiments, the ANC information database 40 is integrated in the ANC computing device 30. In other embodiments, the ANC information database 40 is external to the ANC computing device 30. For example, the ANC computing device 30 may include one or more hard disk drives as the ANC information database 40. In other embodiments, the ANC information database 40 is external to the ANC computing device 30 and may be accessed by a plurality of database servers. For example, the ANC information database 40 may include multiple storage units such as hard disks or solid-state disks in a redundant array of inexpensive disks (RAID) configuration. The ANC information database 40 may include a storage area network (SAN) and/or a network attached storage (NAS) system.

In some embodiments, the processor 202 is operatively coupled to the ANC information database 40 via a storage interface 212. The storage interface 212 is any component capable of providing the processor 202 with access to the ANC information database 40. The storage interface 212 may include, for example, an Advanced Technology Attachment (ATA) adapter, a Serial ATA (SATA) adapter, a Small Computer System Interface (SCSI) adapter, a RAID controller, a SAN adapter, a network adapter, and/or any component providing the processor 202 with access to the ANC information database 40.

The memory device 204 includes, but is not limited to, random access memory (RAM) such as dynamic RAM (DRAM) or static RAM (SRAM), read-only memory (ROM), erasable programmable read-only memory (EPROM), electrically erasable programmable read-only memory (EEPROM), and non-volatile RAM (NVRAM). The above memory types are exemplary only and are thus not limiting as to the types of memory usable for storage of a computer program.

In some embodiments, it is contemplated that the ANC computing device 30 is implemented as a software application. In such embodiments, the hardware described above, such as the processor 202, the memory device 204, the transceiver 210, and/or the storage interface 212 may be shared with the hardware components of another database server, such as the processor 202, the memory device 204, and/or the transceiver 210.

In the exemplary embodiment, the ANC information database 40 stores one or more programs for controlling the processor 202. The programs include program instructions, operation, and/or steps (which may be referred to as computer-readable instructions) that contain executable operations of the ANC computing device 30. When the processor 202 executes the computer-readable instructions, it causes the ANC computing device 30 to function as described herein.

The programs include, for example, one or more conventional operating systems (not shown) that control the processor 202 so as to manage and coordinate activities and sharing of resources in the wallet ANC computing device 30, and to serve as a host for application programs that run on the ANC computing device 30. The one or more conventional operating systems include, for example, and without limitation, UNIX, LINUX, Microsoft Windows®, macOS®, OS X®, etc. More specifically, the computer-readable instructions may cause various data manipulations on data stored in the ANC information database 40 (e.g., create, read, update, and delete procedures). It should also be appreciated that upon initiation of a computer-based method, various computer-readable instructions may be executed during initialization. Some operations may be required to perform one or more processes described herein, while other operations may be more general and/or specific to a programming language (e.g., C, C#, C++, Java, or other suitable programming languages, etc.).

The programs stored in the ANC information database 40 include, for example, an account registration application 214 that, when executed by the processor 202, enables the ANC computing device 30 to handle requests from cardholders, such as the cardholder 22 (shown in FIG. 1), and/or other entities, such as the card issuer 18, merchant 12, and/or organizations/government entities 28, to register for automatic name change services provided by the ANC computing device 30. Using the account registration application 214, the cardholder 22 and/or other entities create an account. The account operates to allow the cardholder 22 and/or other entities to provide account data and/or receive account update services maintained by the ANC computing device 30.

In addition, the ANC information database 40 includes the account information for each respective registered account stored in the account information table 44. The account information table 44 includes, for each respective registered cardholder account, a current legal name, a current address, a unique account identifier (e.g., an SSN), and contact information (e.g., phone number, email, etc.). For each account of a cardholder, the account information table 44 may also include outdated account information that is linked to the corresponding current account information (e.g., a previous legal name, address, and/or contact information).

The ANC information database 40 also includes the cardholder update file 46. The cardholder update file 46 includes account information for each registered cardholder 22 that has changed and/or been updated with respect to a respective card issuer 18, merchant 12, and/or organization/government entity. As described herein, the ANC computing device 30 receives updated account information from the SSA server 32 via the update file 42. This updated account information is stored as part of the account information table 44. When a respective card issuer 18, merchant 12, and/or organization/government entity requests or otherwise is to receive updated account information for its respective cardholders, a respective cardholder update file 46 that includes only the updated cardholder account information for that entity is generated and provided by the ANC computing device 30.

The ANC information database 40 also includes the ANC update status table 50. As described herein, the ANC update status table 50 generally includes account data regarding automatic name change update activity. For example, the ANC update status table 50 includes the one or more account identifiers (e.g., SSNs) for each registered cardholder 22. For each respective account identifier, the ANC update status table 50 includes each associated account and/or license associated therewith, and their respective associated organization and/or government entity. The ANC update status table 50 also includes information indicating when each account and/or license was last updated.

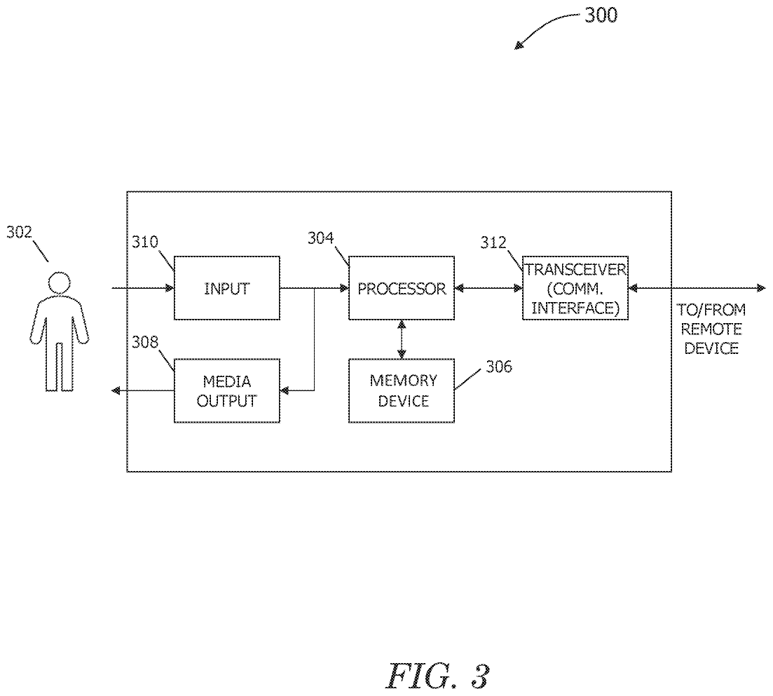

FIG. 3 is an example configuration of a computing system 300 operated by a user 302. In some embodiments, the computing system 300 is a cardholder mobile device 26, a merchant's computing device, and/or an acquirer's computing device (all shown in FIG. 1).

In the example embodiment, the computing system 300 includes one or more processors 304 for executing instructions. In some embodiments, executable instructions are stored in a memory device 306. The processor 304 may include one or more processing units arranged, for example, in a multi-core configuration. The memory device 306 is any device allowing information such as executable instructions, data, and/or written works to be stored and retrieved. The memory device 306 includes one or more computer readable media.

The computing system 300 also includes at least one media output component 308 for presenting information to the user 302. The media output component 308 is any component capable of conveying information to the user 302. In some embodiments, the media output component 308 includes an output adapter such as a video adapter and/or an audio adapter. An output adapter is operatively coupled to the processor 304 and operatively connectable to an output device such as a display device, a liquid crystal display (LCD), organic light emitting diode (OLED) display, or “electronic ink” display, or an audio output device, a speaker, or headphones.

In some embodiments, the computing system 300 includes an input device 310 for receiving input from the user 302. The input device 310 may include, for example, a touch sensitive panel, a touch pad, a touch screen, a stylus, a photographic element or camera, an optical sensor, a gyroscope, an accelerometer, a position detector, a keyboard, a pointing device, a mouse, or an audio input device. A single component such as a touch screen may function as both an output device of the media output component 308 and the input device 310. The computing system 300 may also include a transceiver 312 (broadly, a communication interface), which is communicatively connectable to a remote device such as the ANC computing device 30 (shown in FIG. 1). The transceiver 312 may include, for example, a wired or wireless network adapter or a wireless data transceiver for use with radio frequency communication, near field communication (NFC), and/or with a mobile phone network, Global System for Mobile communications (GSM), 3G, or other mobile data network, and/or Worldwide Interoperability for Microwave Access (WiMax) and the like.

Stored in the memory device 306 are, for example, computer readable instructions for providing a user interface to the user via the media output component 308 and, optionally, receiving and processing input from the input device 310. The user interface may include, among other possibilities, a web browser and various software applications. Web browsers enable users to display and interact with media and other information typically embedded on a web page or a website. The various software applications allow the user 302 to interact with the computing system 300 to further communicate with the ANC computing device 30, other cardholder mobile devices, other client systems, payment systems, etc. to facilitate receiving/providing various services.

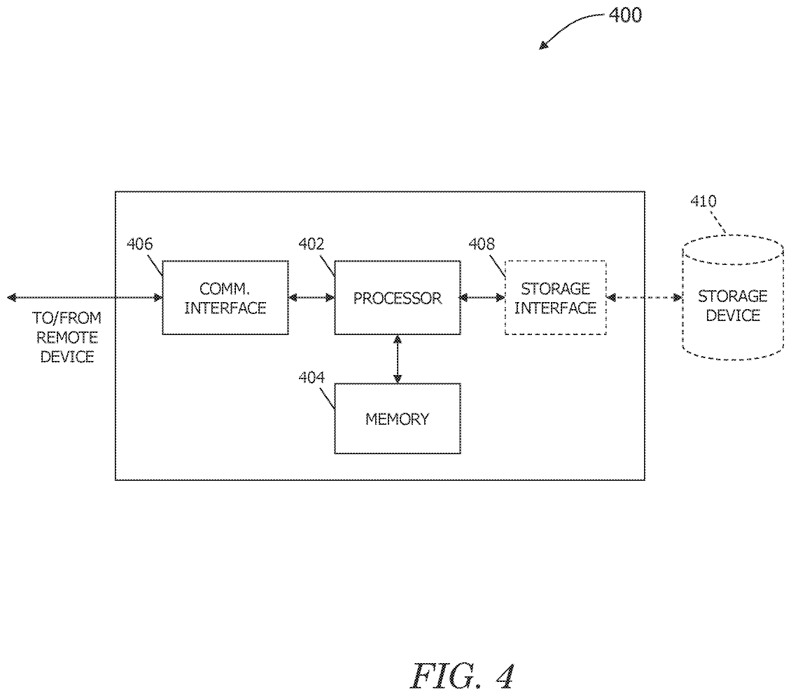

FIG. 4 is an example configuration of a server system 400, such as the interchange network 16, SSA server 32, etc. (shown in FIG. 1). In the example embodiment, the server system 400 includes a processor 402 for executing instructions. The instructions may be stored in a memory area 404, for example. The processor 402 includes one or more processing units (e.g., in a multi-core configuration) for executing the instructions. The instructions may be executed within a variety of different operating systems on the server system 400, such as UNIX, LINUX, Microsoft Windows®, etc. More specifically, the instructions may cause various data manipulations on data stored in a storage device 410 (e.g., create, read, update, and delete procedures). It should also be appreciated that upon initiation of a computer-based method, various instructions may be executed during initialization. Some operations may be required to perform one or more processes described herein, while other operations may be more general and/or specific to a programming language (e.g., C, C#, C++, Java, or other suitable programming languages, etc.).

The processor 402 is operatively coupled to a communication interface 406 such that the server system 400 can communicate with a remote device such as cardholder mobile device 26, the ANC computing device 30, a computing system 300, or another server system. For example, the communication interface 406 may receive communications from an acquirer computing system 300 and the ANC computing device 30.

The processor 402 is operatively coupled to the storage device 410. The storage device 410 is any computer-operated hardware suitable for storing and/or retrieving data. In some embodiments, the storage device 410 is integrated in the server system 400. In other embodiments, the storage device 410 is external to the server system 400 and is like a transaction database. For example, the server system 400 may include one or more hard disk drives as the storage device 410. In other embodiments, the storage device 410 is external to the server system 400 and may be accessed by a plurality of server systems 400. For example, the storage device 410 may include multiple storage units such as hard disks or solid-state disks in a redundant array of inexpensive disks (RAID) configuration. The storage device 410 may include a storage area network (SAN) and/or a network attached storage (NAS) system.

In some embodiments, the processor 402 is operatively coupled to the storage device 410 via a storage interface 408. The storage interface 408 is any component capable of providing the processor 402 with access to the storage device 410. The storage interface 408 may include, for example, an Advanced Technology Attachment (ATA) adapter, a Serial ATA (SATA) adapter, a Small Computer System Interface (SCSI) adapter, a RAID controller, a SAN adapter, a network adapter, and/or any component providing the processor 402 with access to the storage device 410.

The memory area 404 includes, but is not limited to, random access memory (RAM) such as dynamic RAM (DRAM) or static RAM (SRAM), read-only memory (ROM), erasable programmable read-only memory (EPROM), electrically erasable programmable read-only memory (EEPROM), and non-volatile RAM (NVRAM). The above memory types are exemplary only and are thus not limiting as to the types of memory usable for storage of a computer program.

In some embodiments, it is contemplated that the server system 400 is implemented as a software application. In such embodiments, the hardware described above, such as the processor 402, the memory area 404, the communication interface 406, and/or the storage interface 408 may be shared with the hardware components of a computing system 300, such as the processor 304, the memory device 306, and/or the transceiver 312.

### Exemplary Computer-Implemented Methods

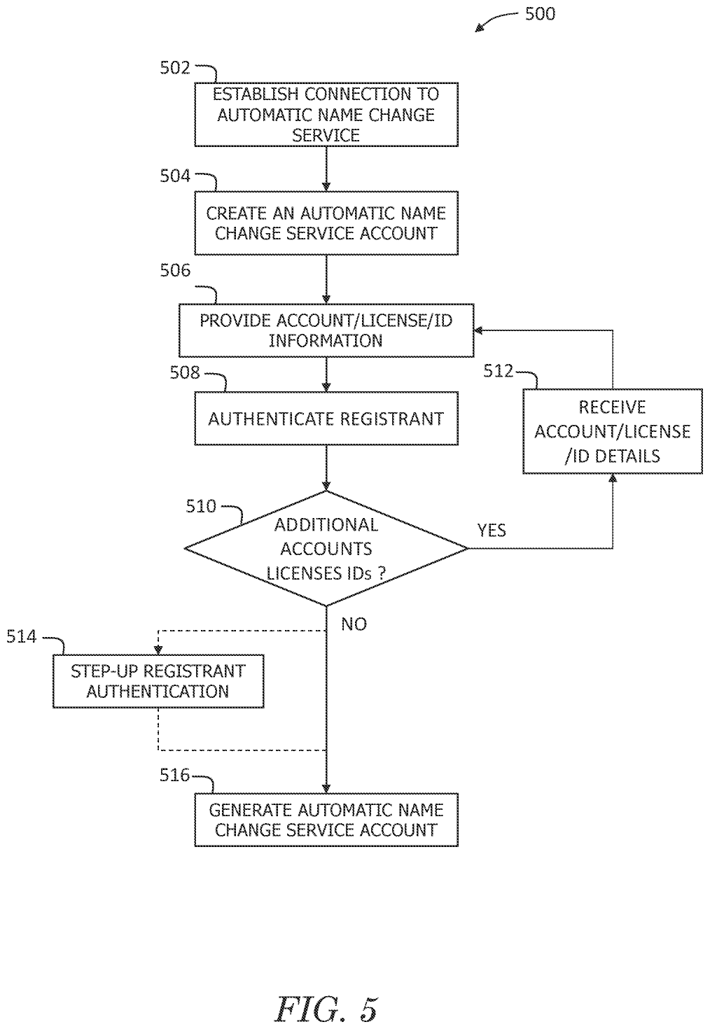

FIG. 5 is a flowchart illustrating an exemplary computer-implemented method 500 for registering one or more of the consumer 22, card issuer 18, merchant 12, and/or organization/government entity (any of which are referred to below as the registrant) for the automatic name change service provided by the ANC computing device 30, in accordance with one embodiment of the present disclosure. The operations described herein may be performed in the order shown in FIG. 5 or, according to certain inventive aspects, may be performed in a different order. Furthermore, some operations may be performed concurrently as opposed to sequentially, and/or some operations may be optional, unless expressly stated otherwise or as may be readily understood by one of ordinary skill in the art.

The computer-implemented method 500 is described below, for ease of reference, as being executed by exemplary devices and components introduced with the embodiments illustrated in FIGS. 1-4. In one embodiment, the computer-implemented method 500 is implemented by the ANC computing device 30 (shown in FIG. 1). In the exemplary embodiment, the computer-implemented method 500 relates to receiving registration information from one or more of the consumer 22, card issuer 18, merchant 12, and/or organization/government entity (shown in FIG. 1) upon registration for the automatic name change service. While operations within the computer-implemented method 500 are described below regarding the ANC computing device 30, according to some aspects of the present invention, the computer-implemented method 500 may be implemented using any other computing devices and/or systems through the utilization of processors, transceivers, hardware, software, firmware, or combinations thereof. A person having ordinary skill will also appreciate that responsibility for all or some of such actions may be distributed differently among such devices or other computing devices without departing from the spirit of the present disclosure.

One or more computer-readable medium(s) may also be provided. The computer-readable medium(s) may include one or more executable programs stored thereon, wherein the program(s) instruct one or more processors or processing units to perform all or certain of the steps outlined herein. The program(s) stored on the computer-readable medium(s) may instruct the processor or processing units to perform additional, fewer, or alternative actions, including those discussed elsewhere herein.

The registrant must be registered for the automatic name change service to authorize or receive updated account information corresponding to a cardholder's legal name change. Referring to operation 502, in the example embodiment, the registrant connects to the ANC computing device 30 via the interchange network 16, e.g., via a webservice providing automatic name change service registration via use of a web browser. Alternatively, the registrant may access the ANC computing device 30 via the account registration application 214 (shown in FIG. 2), which is configured for direct connection to the ANC computing device 30. In such instances, the application may be stored in a cloud-based interface, which may include cloud storage capability as well as any cloud-based API that facilitates communication between a registrant computing device and the ANC computing device 30.

At operation 504, the registrant is presented an option to create an automatic name change service account. For example, the registrant registers or enrolls for the automatic name change service via a suitable webpage of the ANC computing device 30 using, for example, a registrant computing device. It should be understood that the registrant may enroll or register with the automatic name change service in any of several ways, including utilizing a suitable computing device to access the ANC computing device 30 via the Internet and providing the requisite information. During enrollment, the registrant may provide enrollment data including basic information about itself (e.g., name, address, phone number, etc.) and, in some embodiments, provide information regarding the registrant's computing device (for example, by providing a hardware identifier, a SIM identifier, a mobile telephone number, and/or other computing device identifier). It is noted that the automatic name change service account can be linked to other Mastercard services if the registrant is already signed up for other unrelated services. In some embodiments, the information obtained from the registrant during the enrollment process includes product and/or service preferences, requirements data, and/or other information.

At operation 506, the registrant provides information concerning its associated accounts/licenses/IDs. For example, for a cardholder, such as cardholder 22, the associated accounts may include one or more payment cards (e.g., a bank credit card primary account number, debit card primary account number, loyalty card primary account number, gift card primary account number, and the like), loans, mortgages, securities or investment accounts, and the like issued to or held by him or her. For an entity, such as a card issuer 18, merchant 12, and/or organization/government entity, the associated accounts may include one or more accounts/licenses/IDs maintained by the entity, wherein the accounts/licenses/IDs are associated to a cardholder by the cardholder's SSN.

At operation 508, the ANC computing device 30 authenticates the registrant. For example, and without limitation, the ANC computing device 30 may authenticate the registrant via a one-time code sent to the registrant, for example, via Short Message Service (SMS), e-mail, through a call center communication, and the like. Alternatively, or in addition, for the cardholder 22, the cardholder may be asked to input a string of characters indicating a code printed on the signature panel of the cardholder's payment card 24. The signature panel code may be, for example, a card verification code (CVC) value. The values entered by the cardholder 22 may be used by the ANC computing device 30 to authenticate the cardholder 22 prior to setting up the automatic name change service account and associating the cardholder 22 and the cardholder's payment card 24 with the account. For example, the ANC computing device 30 compares the entered values to the values associated with the payment card stored in a database (e.g., the database 40 shown in FIG. 1). If the entered values match the stored values, the cardholder 22 is authenticated. Optionally, the method 500 may include an additional operation for authenticating the registrant offline. For example, and without limitation, the ANC computing device 30 may provide an offline PIN to the registrant via mail.

At operation 510, the ANC computing device 30 asks the registrant whether the registrant has additional payment cards or accounts/licenses/IDs it wishes to associate with the automatic name change service account. If the registrant has additional payment cards or accounts/licenses/IDs to enter, at operation 512, the ANC computing device 30 receives the payment card or account/license/ID details from the registrant and returns to operation 506. If the registrant does not have any additional payment cards or accounts/licenses/IDs to enter, the method continues to optional operation 514 or operation 516.

At optional operation 514, the ANC computing device 30 requests that the registrant set up a step-up authentication method, such as, two-factor authentication. For example, and without limitation, in one embodiment, the registrant is requested to establish account access credentials, e.g., to select a username and password or PIN (personal identification number) to be used for security purposes, and/or for use by the registrant to login and change one or more preferences related to the automatic name change service. In addition to the password or PIN, the registrant may be requested to set up a second authentication factor that is to be associated with the other registration information provided.

In one suitable embodiment, the second factor may include, for example, and without limitation, SMS two-factor authentication (where a one-time use short code is sent to the registrant's computing device via SMS), Time-Based One Time Password (TOTP) authentication (where an authenticator application provides a short code as a second factor), push-based two-factor authentication (where a prompt is pushed out to the registrant's computing device), or any other two-factor authentication method that enables the method 500 to operate as described herein.

In another suitable embodiment, the second factor may include a biometric sample. Biometric samples include, without limitation, a fingerprint image, a voice recording, a retinal image, facial recognition, palm print image, iris recognition, and the like. The biometric sample is unique to the registrant (e.g., the cardholder 22) and difficult to duplicate and/or forge by an unauthorized user. The biometric sample may be stored and associated with a biometric identifier, for example, by the ANC computing device 30 (e.g., in the database 40, etc.). Additionally, the biometric identifier may be associated with the stored registration information and facilitates secure authorization of requested data input by the registrant. A biometric input device in communication with the registrant's computing device may be used for the registrant to enter the biometric sample. For example, the registrant's computing device may include an integral fingerprint or palm reader/scanner, retinal or iris reader/scanner, and/or voice reader/recorder.

At operation 516, the ANC computing device 30 generates the automatic name change service account for the registrant, associating the received one or more payment cards or accounts/licenses/IDs with the account along with the registrant's account access credentials, and stores the automatic name change service account in a database, e.g., the database 40.

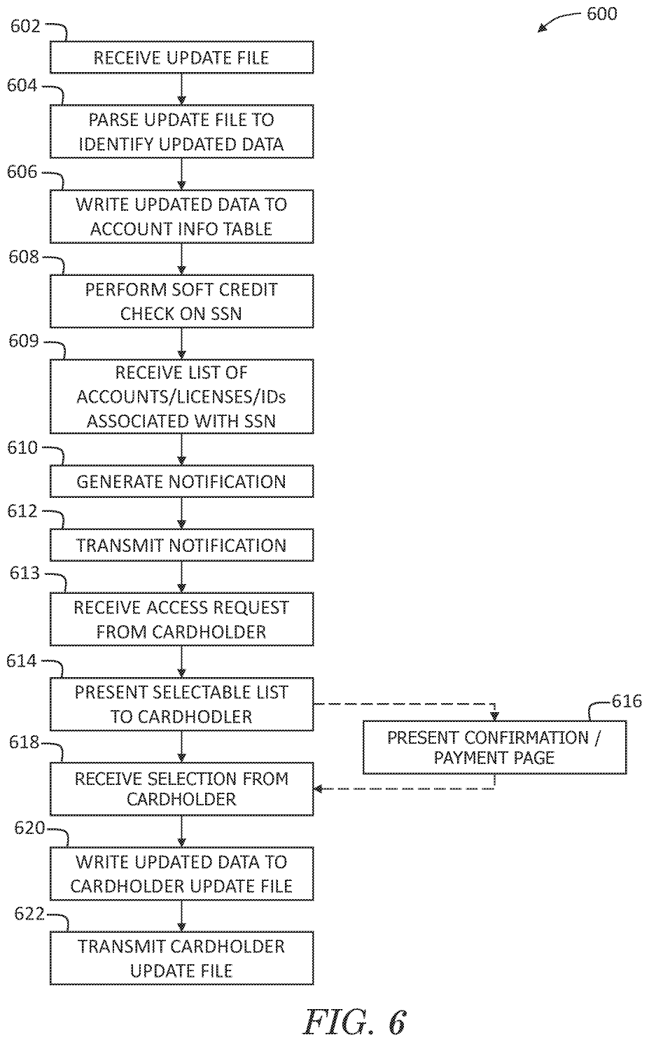

FIG. 6 depicts a flowchart illustrating an exemplary computer-implemented method 600 for automatically updating an accountholder's legal name on one or more associated accounts based on updated SSN account data, in accordance with one embodiment of the present disclosure. The operations described herein may be performed in the order shown in FIG. 6 or, according to certain inventive aspects, may be performed in a different order. Furthermore, some operations may be performed concurrently as opposed to sequentially, and/or some operations may be optional, unless expressly stated otherwise or as may be readily understood by one of ordinary skill in the art.

The computer-implemented method 600 is described below, for ease of reference, as being executed by exemplary devices and components introduced with the embodiments illustrated in FIGS. 1-5. In one embodiment, the computer-implemented method 600 is implemented by the ANC computing device 30. In the exemplary embodiment, the computer-implemented method 600 relates to receiving updated SSN account data, retrieving associated consumer accounts, and providing updated name change services to corresponding account holders. While operations within the computer-implemented method 600 are described below regarding the ANC computing device 30, according to some aspects of the present invention, the computer-implemented method 600 may be implemented using any other computing devices and/or systems through the utilization of processors, transceivers, hardware, software, firmware, or combinations thereof. A person having ordinary skill will also appreciate that responsibility for all or some of such actions may be distributed differently among such devices or other computing devices without departing from the spirit of the present disclosure.

One or more computer-readable medium(s) may also be provided. The computer-readable medium(s) may include one or more executable programs stored thereon, wherein the program(s) instruct one or more processors or processing units to perform all or certain of the steps outlined herein. The program(s) stored on the computer-readable medium(s) may instruct the processor or processing units to perform additional, fewer, or alternative actions, including those discussed elsewhere herein.

In an example aspect of the present invention, an individual, such as the cardholder 22 (shown in FIG. 1), acquires finalized legal documentation for changing their legal name. For example, in an embodiment, the cardholder 22 provides an Application for Social Security Card form (SS-5) to the U.S. Social Security Administration (SSA) with evidence of the cardholder's name change. The included evidence may include, for example, one or more of the following: a marriage certificate, a divorce decree, a certificate of U.S. naturalization, a court order granting the name change, and the like. The cardholder 22 must also provide proof of the cardholder's identity. The proof of identity may include, for example, one or more of the following: a U.S. passport, a driver's license, a state-issued ID card, a U.S. birth certificate, a certification of naturalization, a certificate of citizenship, a U.S. consular report of birth abroad, and the like. The SSA may inquire as to whether the cardholder 22 would like to participate in an automatic name change process. If the cardholder 22 agrees to participate, the SSA flags the cardholder's SSN account for automatic name change. Upon processing the cardholder's name change, the SSA includes the cardholder's updated information in an update file, such as the update file 42 described herein.

At operation 602, the ANC computing device 30 receives the update file 42 from the SSA server 32. In an example embodiment, the ANC computing device 30 submits an update request to the SSA server 32. The update request may include one or more account identifiers, such as one or more cardholder Social Security Numbers (SSNs), corresponding to cardholders for which the interchange network 16 is requesting current account information. Alternatively, in another embodiment, the ANC computing device 30 may automatically receive the update file 42 from the SSA server 32 at a predetermined interval (e.g., weekly, monthly, etc.).

In the example embodiment, the update file 42 includes, for example, one or more records associated with individuals, such as the cardholder 22. Each record is associated with a respective cardholder. Each record includes, for the respective cardholder, one or more of the following: the cardholder's Social Security Number (SSN), current legal first name, new legal first name (if applicable), current legal last name, new legal last name (if applicable), home address, and email address.

At operation 604, the ANC computing device 30 parses the update file 42 to identify the updated record data for each respective SSN or record. At operation 606, the ANC computing device 30 writes the updated record data to the account information table 44 stored on the database 40 for each corresponding SSN or record. That is, the ANC computing device 30 identifies SSNs in the update file 42 that match SSNs in the account information table 44 and writes the associated updated record data to the account information table 44. For example, if the update file 42 includes a new legal first and/or last name, home address, and/or contact information (e.g., email address, phone number, etc.) for one or more cardholders, the ANC computing device 30 writes the updated/new data to the account information table 44 for each respective cardholder. In this manner, the ANC computing device 30 maintains the outdated account information and includes or links the updated account information thereto. As a result, the ANC computing device 30 can use the outdated account information to locate the corresponding updated account information in the database 40, for example, based on any submitted outdated account information.

At operation 608, for each cardholder record that includes a new (i.e., updated) legal name, the ANC computing device 30 performs soft credit check on the corresponding SSN. As discussed herein, the soft credit check facilitates identifying the financial accounts, licenses, etc. associated with the cardholder 22 to determine what organizations and/or entities should receive the updated account information. The soft credit check is a credit check that does not affect the credit score of the cardholder 22. To perform a soft credit check, the ANC computing device 30 may transmit a soft inquiry directly to a credit check server (e.g., an Equifax, Experian, and/or TransUnion server, for example (broadly, a third-party server)). Alternatively, the ANC computing device 30 may send a request to a third-party and/or separate computing device (broadly, a third-party server), which may route a soft inquiry to a credit check server. The soft credit check inquiry may include, for example, identifying information for the cardholder 22, such as the cardholder's SSN, previous name, and/or address. After sending the soft credit check inquiry, at operation 609, the ANC computing device 30 receives, from the third-party server, a list of accounts and/or licenses (e.g., one or more) associated with the cardholder 22 that should receive the updated account information. The returned list of accounts and/or licenses may include, for example, credit cards, mortgages, loans, driver's license, passport, professional licenses, etc.

At operation 610, the ANC computing device 30 generates a notification for transmission to the cardholder 22. The notification provides the cardholder 22 with notice that accounts and/or licenses, and the associated entities, require updated account information. Generation of the notification is based on or in response to the identification of updated cardholder information in the update file 42 and subsequent identification of one or more organizations and/or entities that should receive the updated account information. In some embodiments, the notification may include a link or file that includes the identified organizations and/or entities that should receive the updated account information.

At operation 612, the ANC computing device 30 transmits the notification to the cardholder 22. For example, the ANC computing device 30 may transmit the notification to the cardholder 22 via one or more of the following methods: via Short Message Service (SMS), e-mail, and through a call center communication. Upon receipt of the notification, the cardholder 22 may access the provided link or file included in the notification. For example, the cardholder 22 may click the link or file at which point, at operation 613, the ANC computing device 30 receives an access request from the cardholder computing device 26, for example. In response to the access request, the ANC computing device 30 transmits a request to the cardholder 22 (via the cardholder computing device 26, for example) to enter their account credentials. In some embodiments, the ANC computing device 30 performs a step-up authentication process (i.e., two-factor authentication process) on the cardholder 22 before providing access to the account and/or file. For example, the ANC computing device 30 may provide a one-time password to the cardholder 22, for example, via a cardholder computing device (e.g., via SMS or a call center communication) or via email. In the example embodiment, the link and/or file provides direct access to a name change page, which may be provided by the ANC computing device 30 via a secure webservice (i.e., via encrypted communications).

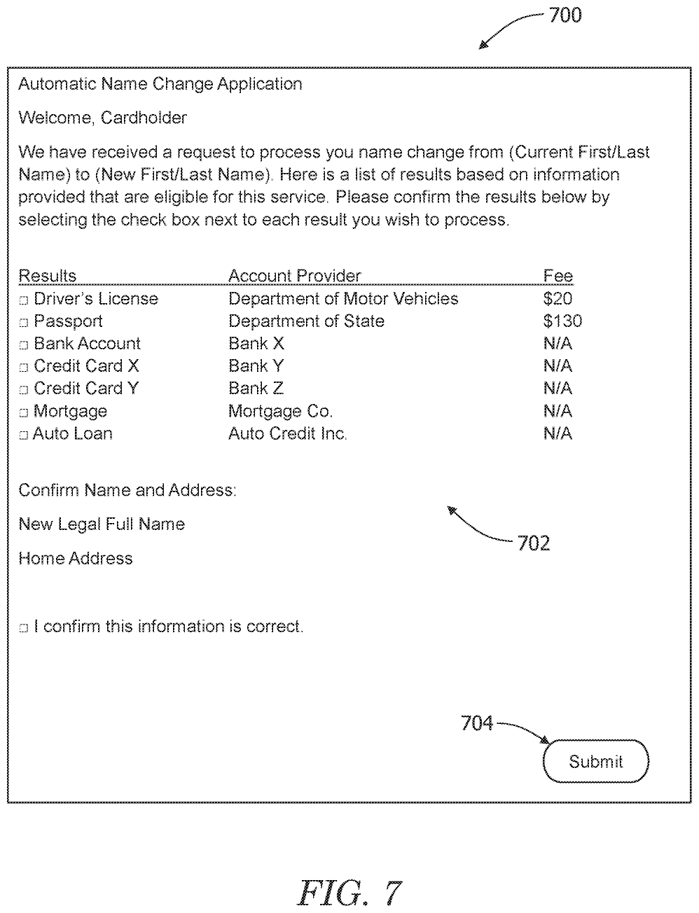

At operation 614, the ANC computing device 30 presents a selectable list of the accounts and/or licenses identified via the soft credit check and the payment cards or accounts/licenses/IDs submitted by the cardholder 22 during registration for the automatic name change service. More particularly, with reference to FIG. 7, the ANC computing device 30 presents a selectable list 702 on a user interface 700 of the cardholder's computing device, such as the cardholder computing device 26 (shown in FIG. 1). The list includes all results tied to the cardholder's SSN and requires the cardholder 22 to individually select and confirm each item that the cardholder 22 wishes to have automatically updated with any name changes. In some embodiments, the list will include any fees required (for example, by the account provider) to update the associated account legal name. The cardholder 22 selects each item he or she wishes to have automatically updated and clicks the submit icon 704.

Optionally, at operation 616, the ANC computing device 30 presents a confirmation page to the cardholder via the user interface 700 of the cardholder's computing device, such as the cardholder computing device 26. The confirmation page may include, for example, the items selected by the cardholder and a total amount due to process the changes based on the fees required by the account provider(s). The cardholder 22 may provide payment information and submit the name change list along with his or her payment information.

At operation 618, the ANC computing device 30 receives, from the cardholder computing device, such as the cardholder computing device 26, a selection of one or more items (i.e., the presented accounts and/or licenses identified via the soft credit check and the payment cards or accounts/licenses/IDs submitted by the cardholder 22 during registration) from the selectable list.

At operation 620, the ANC computing device 30 writes a new entry or updates an existing entry in the cardholder update file 46. The cardholder update file 46 includes account information for each registered cardholder 22 that has changed and/or been updated with respect to a respective account or accounts associated with a single card issuer 18, merchant 12, and/or organization/government entity (i.e., the account providers). In this manner, a respective issuer 18, merchant 12, and/or organization/government entity receives a cardholder update file 46 that only includes account information for registered cardholders 22 which have an account with the respective issuer 18, merchant 12, and/or organization/government entity. This improves the efficiency of the ANC computing device 30 by limiting the processing requirements of the ANC computing device 30 limiting the size of the generated cardholder update files 46.

At operation 622, the ANC computing device 30 transmits the cardholder update file 46 to a computing device associated with the account provider. For example, in one embodiment, the ANC computing device 30 pushes the cardholder update file 46 to the account provider. As noted herein, the ANC computing device 30 may generate and/or update a plurality of cardholder update files 46, wherein each cardholder update file 46 is associated with a respective account provider (i.e., a respective card issuer 18, merchant 12, and/or organization/government entity). In an alternative embodiment, the account provider may retrieve the cardholder update file 46 from the ANC computing device 30 via the application programming interface (API) system 48 (see FIG. 2).

### ADDITIONAL CONSIDERATIONS

All terms used herein are to be broadly interpreted unless otherwise stated. For example, the term “payment card” and the like may, unless otherwise stated, broadly refer to substantially any suitable transaction card, such as a credit card, a debit card, a prepaid card, a charge card, a membership card, a promotional card, a frequent flyer card, an identification card, a prepaid card, a gift card, and/or any other device that may hold payment account information, such as mobile phones, Smartphones, personal digital assistants (PDAs), key fobs, and/or computers. Each type of transaction card can be used as a method of payment for performing a transaction.

As used herein, the term “cardholder” may refer to the owner or rightful possessor of a payment card. As used herein, the term “cardholder account” may refer specifically to a PAN or more generally to an account a cardholder has with the payment card issuer and that the PAN is or was associated with. As used herein, the term “merchant” may refer to a business, a charity, or any other entity that can generate transactions with a cardholder account through a payment card network.

In this description, references to “one embodiment,” “an embodiment,” or “embodiments” mean that the feature or features being referred to are included in at least one embodiment of the technology. Separate references to “one embodiment,” “an embodiment,” or “embodiments” in this description do not necessarily refer to the same embodiment and are also not mutually exclusive unless so stated and/or except as will be readily apparent to those skilled in the art from the description. For example, a feature, structure, act, etc. described in one embodiment may also be included in other embodiments but is not necessarily included. Thus, the current technology can include a variety of combinations and/or integrations of the embodiments described herein.

Although the present application sets forth a detailed description of numerous different embodiments, it should be understood that the legal scope of the description is defined by the words of the claims and equivalent language. The detailed description is to be construed as exemplary only and does not describe every possible embodiment because describing every possible embodiment would be impractical. Numerous alternative embodiments may be implemented, using either current technology or technology developed after the filing date of this patent, which would still fall within the scope of the claims.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order recited or illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein. The foregoing statements in this paragraph shall apply unless so stated in the description and/or except as will be readily apparent to those skilled in the art from the description.

Certain embodiments are described herein as including logic or a number of routines, subroutines, applications, or instructions. These may constitute either software (e.g., code embodied on a machine-readable medium or in a transmission signal) or hardware. In hardware, the routines, etc., are tangible units capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as computer hardware that operates to perform certain operations as described herein.

In various embodiments, computer hardware, such as a processor, may be implemented as special purpose or as general purpose. For example, the processor may comprise dedicated circuitry or logic that is permanently configured, such as an application-specific integrated circuit (ASIC), or indefinitely configured, such as a field-programmable gate array (FPGA), to perform certain operations. The processor may also comprise programmable logic or circuitry (e.g., as encompassed within a general-purpose processor or other programmable processor) that is temporarily configured by software to perform certain operations. It will be appreciated that the decision to implement the processor as special purpose, in dedicated and permanently configured circuitry, or as general purpose (e.g., configured by software) may be driven by cost and time considerations.

Accordingly, the term “processor” or equivalents should be understood to encompass a tangible entity, be that an entity that is physically constructed, permanently configured (e.g., hardwired), or temporarily configured (e.g., programmed) to operate in a certain manner or to perform certain operations described herein. Considering embodiments in which the processor is temporarily configured (e.g., programmed), each of the processors need not be configured or instantiated at any one instance in time. For example, where the processor includes a general-purpose processor configured using software, the general-purpose processor may be configured as respective different processors at separate times. Software may accordingly configure the processor to constitute a particular hardware configuration at one instance of time and to constitute a different hardware configuration at a different instance of time.

Computer hardware components, such as transceiver elements, memory elements, processors, and the like, may provide information to, and receive information from, other computer hardware components. Accordingly, the described computer hardware components may be regarded as being communicatively coupled. Where multiple of such computer hardware components exist contemporaneously, communications may be achieved through signal transmission (e.g., over appropriate circuits and buses) that connect the computer hardware components. In embodiments in which multiple computer hardware components are configured or instantiated at separate times, communications between such computer hardware components may be achieved, for example, through the storage and retrieval of information in memory structures to which the multiple computer hardware components have access. For example, one computer hardware component may perform an operation and store the output of that operation in a memory device to which it is communicatively coupled. A further computer hardware component may then, at a later time, access the memory device to retrieve and process the stored output. Computer hardware components may also initiate communications with input or output devices, and may operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods or routines described herein may be at least partially processor implemented. For example, at least some of the operations of a method may be performed by one or more processors or processor-implemented hardware modules. The performance of certain of the operations may be distributed among the one or more processors, not only residing within a single machine, but deployed across a number of machines. In some example embodiments, the processors may be located in a specific location (e.g., within a home environment, an office environment or as a server farm), while in other embodiments the processors may be distributed across a number of locations.

Unless specifically stated otherwise, discussions herein using words such as “processing,” “computing,” “calculating,” “determining,” “presenting,” “displaying,” or the like may refer to actions or processes of a machine (e.g., a computer with a processor and other computer hardware components) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus.

Although the disclosure has been described with reference to the embodiments illustrated in the attached figures, it is noted that equivalents may be employed, and substitutions made herein, without departing from the scope of the disclosure as recited in the claims.

Having thus described various embodiments of the disclosure, what is claimed as new and desired to be protected by Letters Patent includes the following:

1. An automatic name change system comprising:
a database having an account information table stored thereon, the account information table including a first record having a corresponding first account identifier;
a processor; and
a memory having computer-executed instructions stored thereon, the computer-executable instructions, when executed by the processor, cause the processor to perform operations comprising:
receiving an update file from a first third-party server, the update file including a second record that includes a corresponding second account identifier, a current legal name of a cardholder associated with the second account identifier, and an updated legal name of the cardholder;
based on the second account identifier matching the first account identifier, writing the updated legal name of the cardholder to the first record of the account information table;
transmitting a soft credit check inquiry to a second third-party server, the soft credit check inquiry being associated with the first account identifier;
receiving, from the second third-party server, one or more accounts associated with the first account identifier;
presenting a list of the one or more accounts associated with the first account identifier on a user interface of a cardholder computing device associated with the cardholder, each of the one or more accounts being individually selectable;
receiving, from the cardholder computing device, a selection of one or more of the one or more accounts;
writing the updated legal name of the cardholder to a cardholder update file, wherein the cardholder update file includes only the selected one or more accounts associated with a single account provider; and
transmitting the cardholder update file to a computing device associated with the single account provider.

2. The automatic name change system in accordance with claim 1,
the computer-executable instructions causing the processor to perform an operation comprising, in response to receiving the updated legal name of the cardholder in the update file, transmitting a notification to the cardholder computing device, the notification including notice that the one or more accounts require the updated legal name of the cardholder.

3. The automatic name change system in accordance with claim 2,
the computer-executable instructions causing the processor to perform an operation comprising, in response to the update file including the updated legal name of the cardholder and receipt of the one or more accounts associated with the first account identifier, generating the notification.

4. The automatic name change system in accordance with claim 1,
the computer-executable instructions causing the processor to perform operations comprising parsing the update file and identifying the updated legal name of the cardholder and the corresponding second account identifier.

5. The automatic name change system in accordance with claim 1,
the computer-executable instructions causing the processor to perform operations comprising receiving an access request from the cardholder computing device and,
in response to the access request, transmitting a request to the cardholder computing device requesting that the cardholder enter their account credentials.

6. The automatic name change system in accordance with claim 5,
the computer-executable instructions causing the processor to perform an operation comprising executing a two-factor authentication process with respect to the cardholder providing their account credentials.

7. The automatic name change system in accordance with claim 1,
said operation of writing the updated legal name of the cardholder to a cardholder update file comprises writing the updated legal name of the cardholder to a plurality of cardholder update files, wherein each cardholder update file includes only the one or more selected accounts associated with a single account provider.

8. A computer-implemented method performed by an automatic name change system, the automatic name change system including a database having an account information table stored thereon, the account information table including a first record having a corresponding first account identifier, the method comprising:
receiving an update file from a first third-party server, the update file including a second record that includes a corresponding second account identifier, a current legal name of a cardholder associated with the second account identifier, and an updated legal name of the cardholder;
based on the second account identifier matching the first account identifier, writing the updated legal name of the cardholder to the first record of the account information table;
transmitting a soft credit check inquiry to a second third-party server, the soft credit check inquiry being associated with the first account identifier;
receiving, from the second third-party server, one or more accounts associated with the first account identifier;
presenting a list of the one or more accounts associated with the first account identifier on a user interface of a cardholder computing device associated with the cardholder, each of the one or more accounts being individually selectable;
receiving, from the cardholder computing device, a selection of one or more of the one or more accounts;
writing the updated legal name of the cardholder to a cardholder update file, wherein the cardholder update file includes only the selected one or more accounts associated with a single account provider; and
transmitting the cardholder update file to a computing device associated with the single account provider.

9. The computer-implemented method in accordance with claim 8, further comprising, in response to receiving the updated legal name of the cardholder in the update file, transmitting a notification to the cardholder computing device, the notification including notice that the one or more accounts require the updated legal name of the cardholder.

10. The computer-implemented method in accordance with claim 9, further comprising, in response to the update file including the updated legal name of the cardholder and receipt of the one or more accounts associated with the first account identifier, generating the notification.

11. The computer-implemented method in accordance with claim 8, further comprising parsing the update file and identifying the updated legal name of the cardholder and the corresponding second account identifier.

12. The computer-implemented method in accordance with claim 8, further comprising receiving an access request from the cardholder computing device and, in response to the access request, transmitting a request to the cardholder computing device requesting that the cardholder enter their account credentials.

13. The computer-implemented method in accordance with claim 12, further comprising executing a two-factor authentication process with respect to the cardholder providing their account credentials.

14. The computer-implemented method in accordance with claim 8, wherein writing the updated legal name of the cardholder to a cardholder update file comprises writing the updated legal name of the cardholder to a plurality of cardholder update files, wherein each cardholder update file includes only the one or more selected accounts associated with a single account provider.

15. A non-transitory computer readable storage medium comprising computer readable instructions that, when executed by a processor, cause the processor to perform operations comprising:
receiving an update file from a first third-party server, the update file including a first record that includes a corresponding first account identifier, a current legal name of a cardholder associated with the first account identifier, and an updated legal name of the cardholder;
retrieving an account information table from a database, the account information table including a second record having a corresponding second account identifier;
matching the first account identifier to the second account identifier;
based on the first account identifier matching the second account identifier, writing the updated legal name of the cardholder to the first record of the account information table;
transmitting a soft credit check inquiry to a second third-party server, the soft credit check inquiry being associated with the first account identifier;
receiving, from the second third-party server, one or more accounts associated with the first account identifier;
presenting a list of the one or more accounts associated with the first account identifier on a user interface of a cardholder computing device associated with the cardholder, each of the one or more accounts being individually selectable;
receiving, from the cardholder computing device, a selection of one or more of the one or more accounts;
writing the updated legal name of the cardholder to a cardholder update file, wherein the cardholder update file includes only the selected one or more accounts associated with a single account provider; and
transmitting the cardholder update file to a computing device associated with the single account provider.

16. The computer readable storage medium in accordance with claim 15, wherein the computer readable instructions further cause the processor to perform an operation comprising, in response to receiving the updated legal name of the cardholder in the update file, transmitting a notification to the cardholder computing device, the notification including notice that the one or more accounts require the updated legal name of the cardholder.

17. The computer readable storage medium in accordance with claim 16, wherein the computer readable instructions further cause the processor to perform an operation comprising, in response to the update file including the updated legal name of the cardholder and receipt of the one or more accounts associated with the first account identifier, generating the notification.

18. The computer readable storage medium in accordance with claim 15, wherein the computer readable instructions further cause the processor to perform operations comprising parsing the update file and identifying the updated legal name of the cardholder and the corresponding first account identifier.

19. The computer readable storage medium in accordance with claim 15, wherein the computer readable instructions further cause the processor to perform operations comprising:
receiving an access request from the cardholder computing device and, in response to the access request, transmitting a request to the cardholder computing device requesting that the cardholder enter their account credentials; and
executing a two-factor authentication process with respect to the cardholder providing their account credentials.

20. The computer readable storage medium in accordance with claim 15, wherein the computer readable instructions causing the processor to write the updated legal name of the cardholder to a cardholder update file comprises the computer readable instructions causing the processor to perform the operations of writing the updated legal name of the cardholder to a plurality of cardholder update files, wherein each cardholder update file includes only the one or more selected accounts associated with a single account provider.
